(19) United States
(12) Patent Application Publication
(10) Pub. No.: US 2003/0227425 A1
(43) Pub. Date: Dec. 11, 2003

(54) Communication apparatus incorporating a visual signaling device

(76) Inventors: Michael McKay, Calabasas, CA (US); Nikolaj H. Bestle, Calabasas, CA (US)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/161,802

(22) Filed: Jun. 5, 2002

(51) Int. Cl. G09G 3/00

(52) U.S. Cl. 345/31

(57) ABSTRACT

A communication apparatus incorporating a visual signaling device. A first cover member and a second cover member cooperate to define a communication interior having communication components therein, permitting communication of messages. Keys are operable through one of said cover members to indicate control functions for the communication apparatus. Light emitting devices are visible through one of the cover members. A controller is responsive to operation of the keys to cause the light emitting devices to emit light signals in a pattern indicated by the operation of the keys. An accelerometer is responsive to movement of the communication apparatus to control spacing of the light signals to form a displayed light pattern.

### FIELD

The present invention pertains to a communication apparatus incorporating a visual signaling device. More particularly, the present invention pertains to a wireless communication apparatus, such as a cellular telephone, a personal digital assistant, or a pager, including a linear array of light emitting devices, making the apparatus capable of providing visual patterns recognizable due to persistence characteristics of human eyes.

### BACKGROUND

There frequently exists situations in which it is desirable to create a visual signal viewable at some distance, in order to convey information to someone at such a distance. By way of example, a motorist in an emergency situation may wish to signal approaching traffic to ask for help or to indicate that such traffic should stop so as to avoid a collision. Similarly, persons attending an event such as a rock concert might wish to signal a message to others attending the concert.

Baton type visual signaling devices are known for use by police officers and other traffic control personal. Such devices generally include a linear array of lights which are caused to flash in a manner that creates a visual pattern as the device is swung through the air. See, for example, U.S. Pat. Nos. 5,406,300, 5,670,971, and 6,265,984. Such devices have no use other than visual signaling, and so generally are of interest only to people such as traffic control personnel, for example police officers.

Other people might desire to have a visual signaling device, but not be interested in such a device if the device is only capable of creating a limited number of alphanumeric patterns. Likewise, such people may not desire such a device if the device has no other use, both because of the cost and because of the inconvenience of maintaining a device that is infrequently used.

### SUMMARY

To overcome limitations in the prior art such as described above, various embodiments of a communication apparatus having a visual signaling device incorporated into it are provided. While the embodiments of the invention are described herein with reference to a cellular telephone, embodiments of the invention may be incorporated into other wireless communication devices, for example pagers and personal digital assistants, all referred to as mobile stations.

A mobile station in accordance with embodiments of the present invention includes first and second covers which cooperate to define a mobile station interior. Mobile station components are provided within the mobile station interior and are operable to permit messaging. Alphanumeric keys and at least one control key are operable through one of the covers. The alphanumeric keys are operable to indicate another device to which sending of a message is desired.

A plurality of light emitting devices are visible through one of the covers. A controller is responsive to actuation of the alphanumeric keys and the control key to cause the light emitting devices to emit light signals in a pattern indicated by the keys. An accelerometer is responsive to movement of the mobile station to control the spacing of the light signals to form a displayed pattern. The displayed pattern might be an alphanumeric pattern or a graphical pattern. The desired pattern can be indicated by operation of the alphanumeric keys. If desired, patterns can be pre-stored in a memory within the mobile station. Likewise, if desired, the mobile station can receive signals from another source indicative of the pattern to be displayed, for example short message service (SMS) or multimedia message service (MMS) signals.

### BRIEF DESCRIPTION OF THE DRAWINGS

These and other aspects and advantages of the present invention are more apparent from the following detailed description and claims, particularly when considered in conjunction with the accompanying drawings in which like parts bear like reference numerals. In the drawings:

FIG. 1 is a front plan view of a typical mobile station incorporating a visual signaling device in accordance with an embodiment of the present invention;

FIG. 2 is a perspective view of components of a mobile station having a visual signaling capability in accordance with an embodiment of the present invention;

FIG. 3 is a perspective view of the mobile station of FIG. 2 assembled;

FIG. 4 is a block diagram of an embodiment of circuitry suitable for use in the mobile station of FIGS. 2 and 3;

FIG. 5 is a perspective view of a mobile station in accordance with embodiments of the present invention creating a visual message;

FIG. 6 depicts a person creating a visual message utilizing a mobile station in accordance with embodiments of the present invention;

FIG. 7 is a perspective view of components of a mobile station having a visual signaling capability in accordance with another embodiment of the present invention;

FIG. 8 is a perspective view of the mobile station of FIG. 7 assembled;

FIG. 9 is a block diagram of an embodiment of circuitry suitable for use in the mobile station of FIGS. 7 and 8; and

FIG. 10 is a perspective view of a mobile station in accordance with the present invention creating a graphic pattern.

### DETAILED DESCRIPTION OF PREFERRED EMBODIMENTS

In the following description of various embodiments of the present invention, reference is made to the accompanying drawings which form apart hereof and in which are shown by way of illustration various embodiments in which the invention may be practiced. It is to be understood that other embodiments may be utilized, and that structural and functional modifications may be made without departing from the scope of the present invention. In particular, while the following detailed description makes reference to the communication device of the present invention as a mobile station, other embodiments of communication devices might also be provided in accordance with the invention.

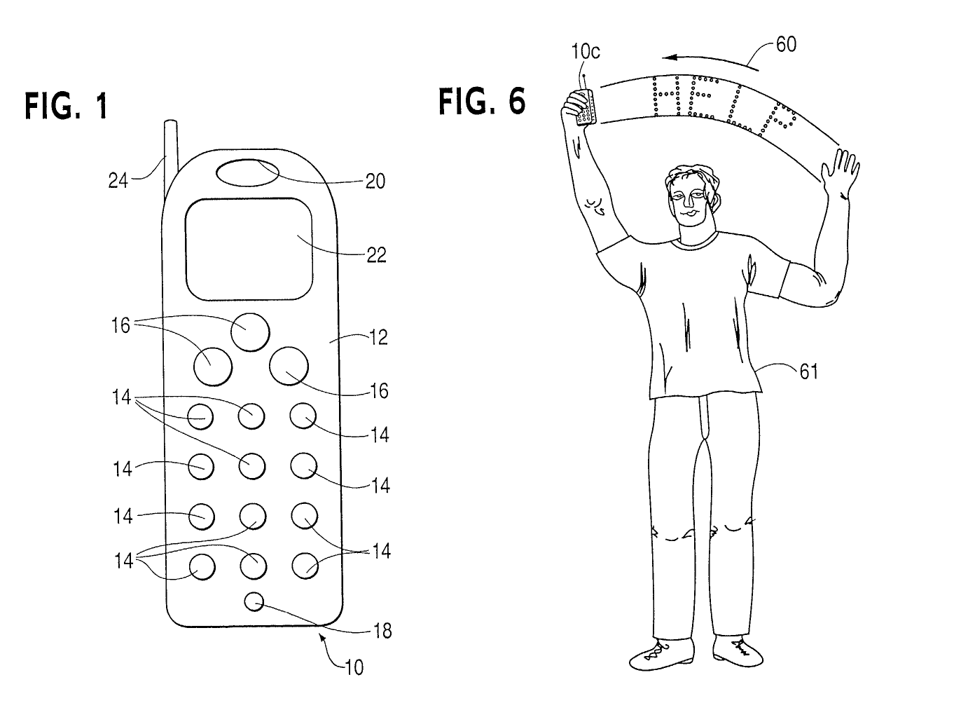

FIG. 1 illustrates a mobile station 10 which is typical of the types of communication devices which can incorporate embodiments of the present invention. Mobile station 10 includes a front cover 12 having locations through which a number of keys are operable. FIG. 1 illustrates the keys of mobile station 10 as including alphanumeric keys 14, which can be used to enter a mobile station number to which a call is to be made and for other functions, and control keys 16, which can be used to indicate control functions. Mobile station 10 also has a microphone 18 and a speaker 20, permitting two way conversation. Preferably, mobile station also has a display unit 22 for displaying data such as a mobile station number to which a call is being placed and such as messages to be created. FIG. 1 depicts mobile station 10 as including an external antenna 24; however, the mobile station might instead be provided with an internal antenna, if desired.

As is well known, mobile station 10 can be used to initiate calls by operating an appropriate one of the control keys 16 to activate the mobile station for placing of a call and by operating appropriate ones of the alphanumeric keys 14 to indicate the number of the other station to which the call is to be made. Mobile station 10 is identified by a unique number such as 555-555-1212. Mobile station 10 can receive calls placed to that number. During mobile station calls, whether outgoing or incoming, the user of the mobile station speaks into microphone 18 and listens to incoming messages through mobile station speaker 20.

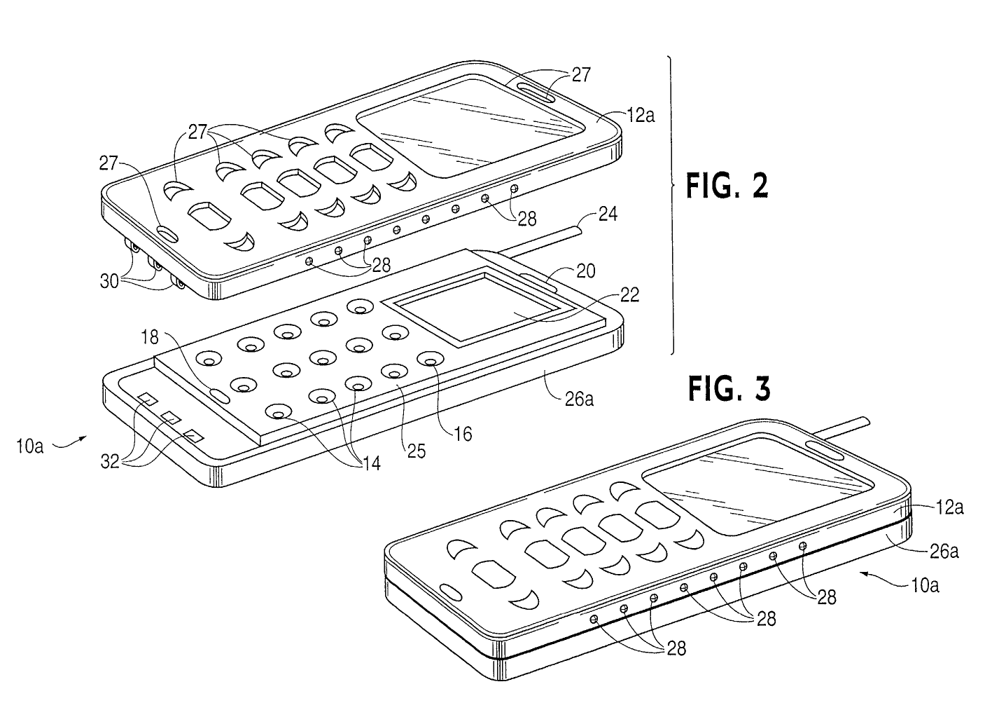

Referring to FIGS. 2 and 3 which illustrate one embodiment a communication device in accordance with the present invention, mobile station 10a includes a front cover 12a and a rear cover 26a which cooperate to define a mobile station interior within which the mobile station components are housed, for example on a printed circuit board 25. These components may include alphanumeric keys 14, control keys 16, microphone 18, speaker 20 and display 22. Front cover 12a might have openings 27 through it permitting operation of and/or viewing of these components. Alternatively, front cover 12a might have the keys 14, 16 within it to cooperate with connective pads or printed circuit board 25. In any event, the keys 14, 16 are operable through cover 12a. Further, if desired front cover 12a might have a lens in the opening 27 over display 22.

In the embodiment of the present invention depicted in FIGS. 2 and 3, front cover 12a has a plurality of light emitting devices 28, such as light emitting diodes, viewable through a side surface of the cover. FIGS. 2 and 3 illustrate eight light emitting devices, although any number might be provided. In addition, front cover 12a includes appropriate circuitry to control light emitting devices 28, as described more fully below. A set of connectors 30 extends from the lower surface of front cover 12a to connect the circuitry and the light emitting devices 28 to mating connectors 32 within rear cover 26a for connection to circuitry on printed circuit board 25.

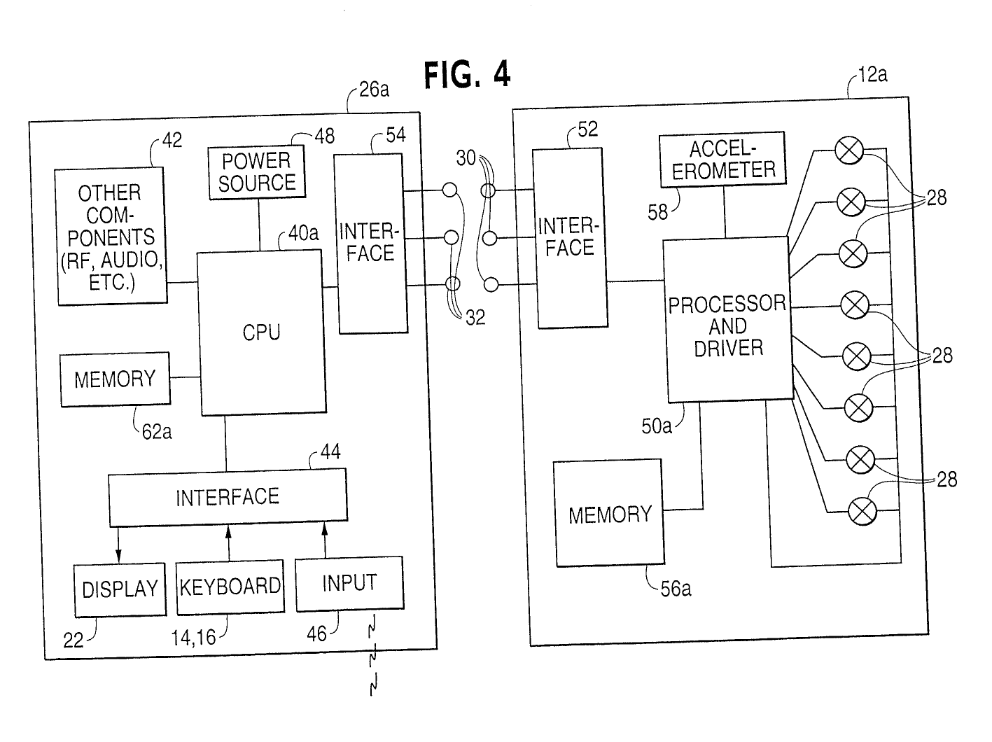

FIG. 4 illustrates an embodiment of circuitry suitable for use within mobile station 10a. Within rear cover 26a, the components may include a central processing unit 40a which is connected to the other components 42, including, for example, microphone 18, speaker 20, a program memory that stores the necessary programs for operation of the mobile station, and a data memory which stores relevant data such as an automatic dialing directory or identification of numbers which have placed an unanswered call to the mobile station, together with other components such as amplifiers. Such mobile stations are well known in the art. In addition, central processing unit 40a is connected through interface 44 to a keyboard including alphanumeric keys 14 and control keys 16 and to display 22. Further, if desired, interface 44 may connect central processing unit 40a to other inputs 46, for example from a wireless network, permitting receipt of messages. Central processing unit 40a is also connected to a power source 48 such as a battery.

Within front cover 12a, light emitting devices 28 are connected to a processor and driver 50a which is coupled through interface 52 to connectors 30. Similarly, within rear cover 26a CPU 40a is coupled through interface 54 to connectors 32. Thus, when front cover 12a is positioned on rear cover 26a, as depicted in FIG. 3, CPU 40a is coupled to processor and driver 50a. Operation of a selected one of the control keys 16 activates the signaling mode of mobile station 10a, enabling light signals to be created by light emitting devices 28. The light signals might be created by operating alphanumeric keys 14 to apply coded indications of the desired light signals through CPU 40a and connectors 32 and 30 to processor and driver 50a. The coded indications are then stored in a memory 56a within front cover 12a.

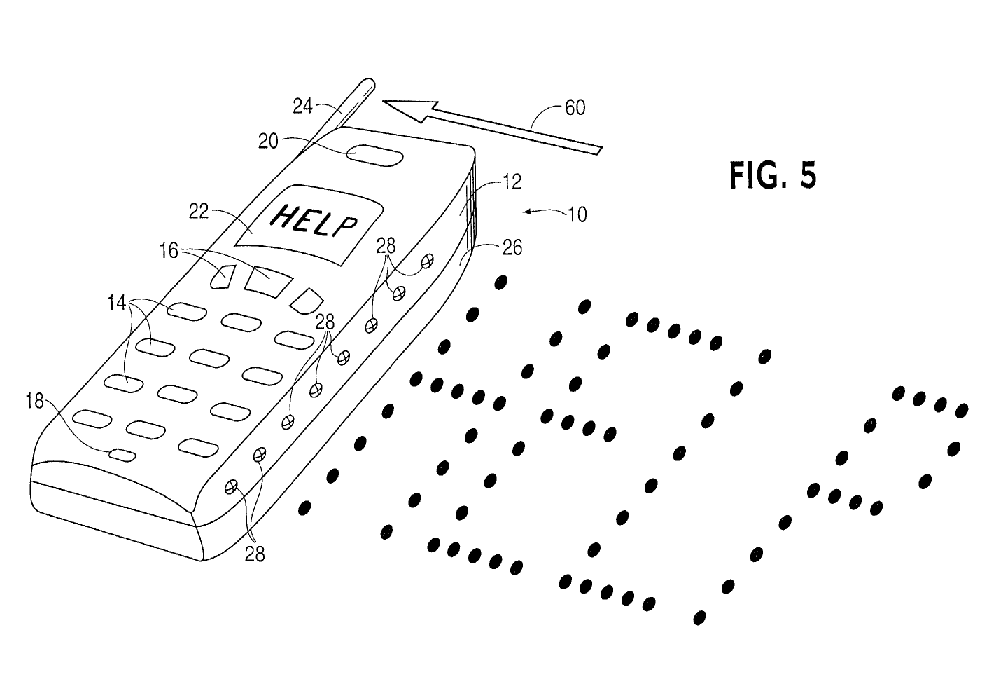

FIG. 5 depicts a mobile station 10 in accordance with the present invention emitting light signals in a pattern forming an alphanumeric message of the word “HELP.” In order to enable the flashing of the light emitting devices to create the letters H, E, L, and P, those letters may be stored in memory 56a in a dot matrix pattern, for example in a memory map. The pattern is then read out from memory 56a to processor and driver 50a which activates the light emitting devices 28 in accordance with the desired pattern. An accelerometer 58 is connected to processor and driver 50a to sense the movement of mobile station 10a. FIG. 5 illustrate mobile station 10 moving in the direction of arrow 60. That movement is sensed by accelerometer 58 which applies a signal indicative of the direction and speed of movement to processor and driver 50a, enabling the processor and driver to synchronize the light signal pattern so as to form a displayed pattern of the letters of the alphanumeric message. As indicated in FIG. 5, the message that is to be formed may be shown on display 22 so that the user of mobile station 10a can be assured that the desired message is being formed. FIG. 6 illustrates a person 61 standing, as by a disabled vehicle for example, and moving communication apparatus 10c to form a HELP message. Although messages and graphics created by communication apparatus 10c are more visible at night or in a darkened room, still such messages might be discerned in a lighted environment.

As an alternative to creating a message with alphanumeric keys 14, frequently used messages can be stored in a memory 62a within mobile station 10a and selected by operation of a control key 16 and/or alphanumeric key 14. Memory 62a can be a read only memory storing preselected messages or a random access memory into which frequently used messages are stored. Memory 62a can be a separate memory for this purpose or can be a memory forming a part of the components 42.

Additionally, a pattern to be displayed can be received by input 46 and applied through interface 44 to CPU 40a for application to processor and driver 50a and memory 56a. Such a pattern might be received as a SMS message or a MMS message from a wireless network, including the Internet, or from another source. Likewise, a pattern might be received via a short range wireless communication and control link such as a Bluetooth connection or another connection in accordance with IEEE Standard 802.11.

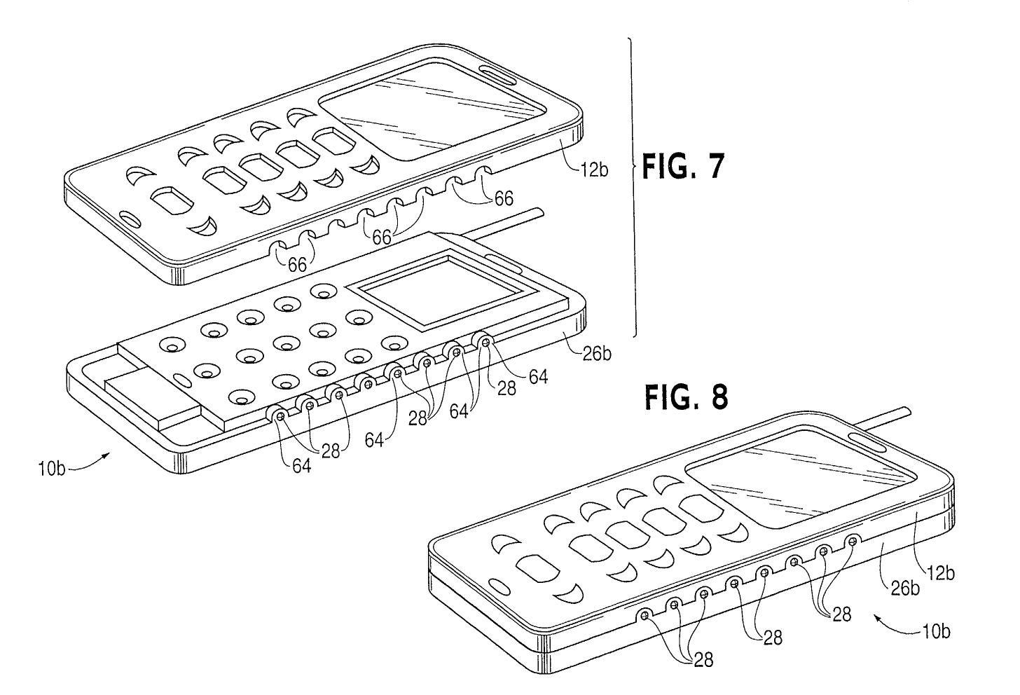

FIGS. 2 and 3 depict the light emitting devices 28 within front cover 12a. FIGS. 7 and 8 depict an embodiment of the present invention in which the light emitting devices 28 are within the rear cover 26b. In the embodiment of FIGS. 7 and 8, each light emitting device 28 is within a support portion 64 which is received within a corresponding recess 66 in front cover 12b.

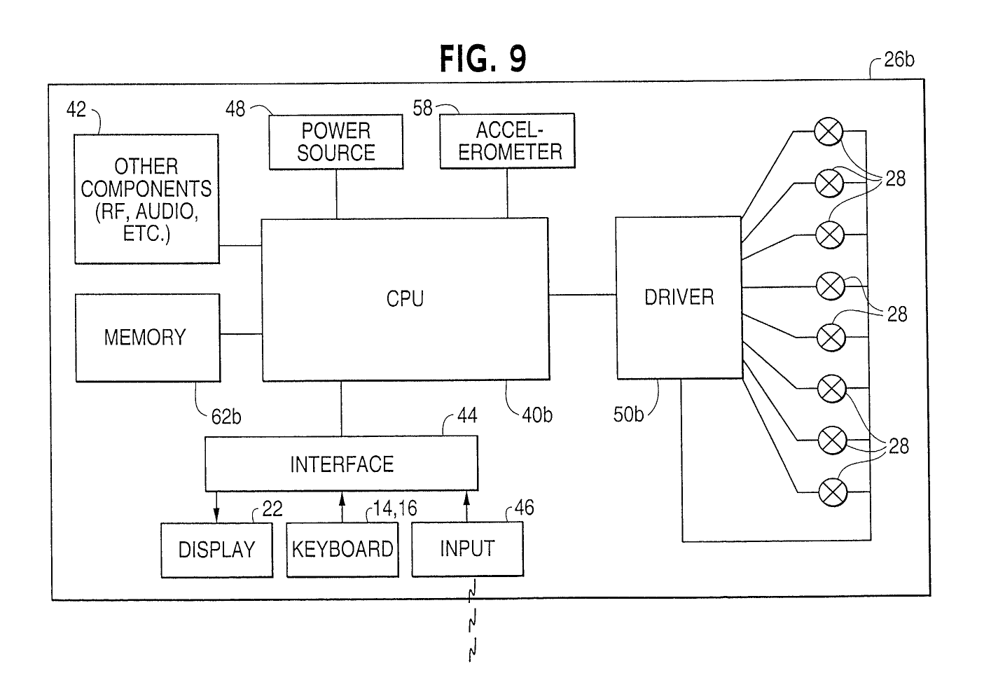

FIG. 9 depicts an embodiment of circuitry suitable for use within mobile station 10b of FIGS. 7 and 8. Since the light emitting devices are in rear cover 26b, some components required in mobile station 10a can be combined. Thus, a CPU 40b and a driver 50b can be utilized in place to CPU 40a and processor and driver 50a. Memory 56a is unnecessary, its function being handled by memory 62b. Accelerometer 58 is connected to CPU 40b. The operation is substantially the same as that of the circuitry of FIG. 4.

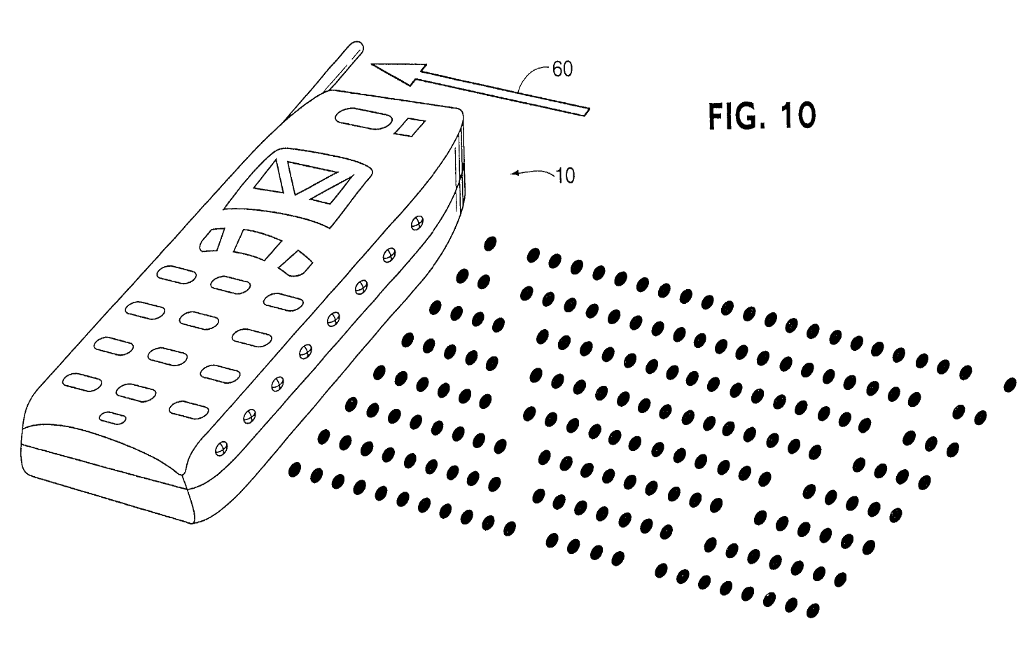

FIG. 10 depicts a mobile station 10 in accordance with the present invention emitting light signals in a pattern forming a graphical display. A dot matrix pattern of the graphical display might be prestored within memory 62a or 62b, for example in a memory map. The dot matrix pattern can be read out from the memory and applied to driver 50a or 50b which activates the light emitting devices 28 in accordance with the pattern and spaced in accordance with the output from accelerometer 58 to form the graphical display.

If communication apparatus 10 is a personal digital assistant, then the apparatus might use a stylus or other input device in place of alphanumeric keys 14. If the communication apparatus 10 is a pager, prestored messages might be selected utilizing a control key 16, with alphanumeric keys 14 being omitted.

It is thus seen that the present invention provides a wireless communication apparatus incorporating a visual signaling device, enabling a user both to engage in wireless communication and to create visual signals. Although the invention has been described with reference to preferred embodiments, various modifications, rearrangements, and substitutions might be made, and still the result will be within the scope of the invention.

What is claimed is:

1. A communication apparatus, comprising a first cover member; a second cover member cooperating with said first cover member to define a communication interior; communication components within the communication interior and operable to permit communication of messages; a plurality of keys operable through one of said cover members to indicate control functions for said communication apparatus; a plurality of light emitting devices visible through one of said cover members; a controller responsive to operation of said keys to cause said light emitting devices to emit light signals in a pattern indicated by said operation of said keys; and an accelerometer responsive to movement of said communication apparatus to control spacing of the light signals to form a displayed light pattern.

2. A communication apparatus as claimed in claim 1, wherein said controller causes said light emitting devices to emit light signals in a pattern providing alphanumeric symbols, to form an alphanumeric message.

3. A communication apparatus as claimed in claim 1, wherein said controller causes said light emitting devices to emit light signals in a graphical pattern, to form a graphical display.

4. A communication apparatus as claimed in claim 1, wherein said light emitting devices comprise light emitting diodes.

5. A communication apparatus as claimed in claim 1, wherein said keys are operable through said first cover member, and said light emitting devices are visible through said first cover member.

6. A communication apparatus as claimed in claim 1, wherein said keys are operable through said first cover member, and said light emitting devices are visible through said second cover member.

7. A communication apparatus as claimed in claim 1, further comprising a memory having stored therein indications of light signal patterns; and wherein said controller is responsive to said operation of said keys to select a stored indication, causing said light emitting devices to emit light signals in a pattern determined by the selected indication.

8. A communication apparatus as claimed in claim 1, wherein said keys include alphanumeric keys.

9. A communication apparatus as claimed in claim 1, wherein said communication apparatus comprises a mobile station.

10. A communication apparatus as claimed in claim 9, wherein said mobile station comprises a cellular telephone .

11. A communication apparatus as claimed in claim 9, wherein said mobile station comprises a pager.

12. A communication apparatus as claimed in claim 9, wherein said mobile station comprises a personal digital assistant.

13. A communication apparatus, comprising a first cover member; a second cover member cooperating with said first cover member to define a communication interior; communication components within the communication interior and operable to permit communication of messages; a plurality of keys operable through one of said cover members to indicate control functions for said communication apparatus; a pattern source for providing indications of light patterns; a plurality of light emitting devices visible through one of said cover members; a controller responsive to operation of said keys to receive from said pattern source a light pattern indication selected said operation of said keys and to apply the received indication to said light emitting devices, causing said light emitting devices to emit light signals in a pattern determined by the selected indication; and an accelerometer responsive to movement of said communication apparatus to control spacing of the light signals to form a displayed pattern.

14. A communication apparatus as claimed in claim 13, wherein said pattern source comprises a memory device.

15. A communication apparatus as claimed in claim 14, wherein said memory device stores alphanumeric patterns to cause said light emitting devices to emit light signals in a selected alphanumeric pattern, forming an alphanumeric message.

16. A communication apparatus as claimed in claim 14, wherein said memory device stores graphical patterns to cause said light emitting devices to emit light signals in a selected graphical pattern, forming a graphical display.

17. A communication apparatus as claimed in claim 13, wherein said pattern source provides alphanumeric patterns to cause said light emitting devices to emit light signals in a selected alphanumeric pattern, forming an alphanumeric message.

18. A communication apparatus as claimed in claim 13, wherein said pattern source provides graphical patterns to cause said light emitting devices to emit light signals in a selected graphical pattern, forming a graphical display.

19. A communication apparatus as claimed in claim 13, wherein said pattern source comprises an input adapted to receive signals from a wireless communication network.

20. A communication apparatus as claimed in claim 13, wherein said light emitting devices comprise light emitting diodes.

21. A communication apparatus as claimed in claim 13, wherein said keys are operable through said first cover member, and said light emitting devices are visible through said first cover member.

22. A communication apparatus as claimed in claim 13, wherein said keys are operable through said first cover member, and said light emitting devices are visible through said second cover member.

23. A communication apparatus as claimed in claim 13, wherein said keys include alphanumeric keys.

24. A communication apparatus as claimed in claim 13, wherein said communication apparatus comprises a mobile station.

25. A communication apparatus as claimed in claim 24, wherein said mobile station comprise a mobile telephone.

26. A communication apparatus as claimed in claim 24, wherein said mobile station comprises a pager.

27. A communication apparatus as claimed in claim 24, where said mobile station comprises a personal digital assistant.
